(19) United States
(12) Patent Application Publication
(10) Pub. No.: US 2003/0124224 A1
(43) Pub. Date: Jul. 3, 2003

(54) Process for the production of enzyme granules

(76) Inventors: Rudolf Carolus Maria Barendse, Delft (NL); Gabriel Marinus Henricus Meesters, Delft (NL); Antonius Johannes Maria Happel, Rotterdam (NL)

Correspondence Address: MORRISON & FOERSTER LLP, 3811 VALLEY CENTRE DRIVE, SUITE 500, SAN DIEGO, CA, 92130-2332, US

(21) Appl. No.: 10/275,515

(22) PCT Filed: Apr. 27, 2001
(86) PCT No.: PCT/EP01/04874

(30) Foreign Application Priority Data
May 4, 2000 (EP) 002016350

(51) Int. Cl. A23K 1/00

(52) U.S. Cl. 426/52

(57) ABSTRACT

The invention describes a process for the continuous production of enzyme granules characterised in that:(h) a liquid enzyme preparation containing one or more enzymes is produced(i) optionally additives are added to the liquid enzyme preparation obtained in (a)(j) one or more liquid enzyme preparations obtained in (a) or (b) are sprayed into a fluidised bed by means of spray nozzles(k) fine material that escapes from the fluid bed with the off-gas is separated off and returned to the fluidised bed as nuclei for the granule formation(l) granules of a predetermined size are formed by adjusting the sifting gas stream(m) the finished granules are discharged via one or more countercurrent gravity sifters installed in the inflow plate of the fluidised bed apparatus(n) optionally the enzyme granules obtained in step (f) are coated. The invention further provides enzyme granules characterised by an isotropic structure, a spherical shape and smooth surface as expressed by a roundness factor between 1 and 1.6 and optionally a coating.

The present invention relates to enzyme granules and a process for the production of said enzyme granules.

In the past decades the use of enzymes in industrial applications has increased in volume, types of enzymes used and in the number of application areas. Most of these enzymes are produced by micro-organisms in large scale fermentation processes. The enzymes are harvested from the broth, or in some cases from the cells, and are worked up to their final stage. The enzymes are supplied as liquid or dry enzyme products; the specifications of the products are dictated mainly by the intended application of the end user.

Enzymes are protein molecules and therefore inherently unstable compounds, in particular in an aqueous medium. The storage stability of enzyme preparations can considerably be improved by formulating the enzyme preparations in a dry state, such as by spray drying. Enzymes are also liable to give rise to allergenic reactions in susceptible persons, especially when these persons are exposed to inhalable enzyme dust. Conventional spray drying techniques yield an inherently dusty powder product due to the small particle size of the resulting particles. Considerable effort has therefore been given to the development of enzyme preparations with reduced dust formation by means of various granulation techniques. An additional advantage of granulates is the improved handling characteristics.

Several different granulation techniques are known for producing enzyme granulates. Most frequently used are multistage drying (MSD), mixer agglomeration, fluid bed agglomeration, fluid bed coating layering and extrusion processes. In most of these processes, the enzyme fraction is introduced either as dry powder, a slurry or as liquid. The use of dry enzyme powders is to be avoided since the production and handling of these powders introduces the allergenic hazards as previously described. The more preferred use of enzyme solutions or slurries, however, requires a dry carrier material in all the processes mentioned except multistage drying.

The use of a carrier is disadvantageous because it increases the cost price of the enzyme granules and puts high demands on the handling and accurate dosage of the dry carriers. Moreover, due to the presence of this inert carrier, the activity level that can be achieved of the resulting product is reduced and also the minimal size of the particles is increased. Therefore, these granulation techniques cannot be used to produce enzyme products for applications where a high activity level is demanded. Also, the costs for storage, packaging and transport per activity unit of these carrier containing products are increased significantly due to the relatively low activity per unit of weight or volume. Furthermore, the use of a carrier is also unsuited for efficient production of enzyme particles with a diameter smaller than several hundredths of microns. This excludes the products from being used in applications where small particles are demanded such as in bakery applications.

Multistage drying does not require dry carriers and therefore does not have the disadvantages described above for the techniques that do require dry carriers. However, multistage drying yields agglomerated and inherently irregular shaped products, which are highly porous and have a low density. The disadvantage of these particles is that their porous nature severely reduces the mechanical strength. Together with the irregular shape this leads to a high susceptibility to attrition and breakage during handling and transport, leading to substantial dust formation.

Patent applications EP-A-0163836 and EP-A-0332929 disclose a process and device for the production of granulate material by means of a continuous fluid bed process (WSA-process) without the need for a dry carrier. The granules can contain one or more active components. All the active components mentioned are low molecular weight organic and inorganic molecules. No suggestion or indication is given that this process and the granules obtained therefrom could be used for inherently unstable high molecular weight biomolecules such as enzymes.

We have now surprisingly found that by using the continuous fluid bed process (WSA-process) for the formulation of enzymes, non-dusting enzyme granules can be obtained with improved characteristics as compared to granules obtained by granulation techniques commonly known.

A continuous fluidised bed process (WSA-process) is defined herein as the process disclosed in the European patent application EP-A-0163836.

Enzymes used in food are defined herein as enzymes that are used as additives or processing aids in the food industry. Food industry is defined as the industry that manufactures food products for human consumption such as baked products (e.g. bread), dairy products (e.g. cheese and other fermented milk products), beverages (e.g. beer, wine, fruit juices, potable alcohol) etceteras. Enzymes used in feed are defined herein as enzymes that are used as additives or processing aids in the feed industry. Feed industry is defined as the industry that manufactures animal feed products such as for poultry, pigs, ruminants, and fish etceteras.

Isotropic structure is defined herein as the structure of a granule that has a homogenous composition and does not contain a solid carrier or core.

The roundness factor is a shape factor, which gives the ratio between the perimeter squared of a certain granule and the perimeter squared of a perfectly round granule. A perfectly round granule has a roundness factor of 1. More or less round granule have a roundness factor>1. A smooth surface is defined as a particle having a roundness factor between 1 and 1.6.

The size distribution of the granules is defined herein as the distribution of the granule size around a diameter (d₅₀) and which is expressed as d₁₀/d₉₀; d₁₀ and d₉₀ represent diameters in the following way: 10% of the mass has a granule diameter smaller than d₁₀ and another 10% of the mass has a granule diameter larger than d₉₀. The theoretical maximal value of d₁₀/d₉₀ is 1, i.e. all granules have the same average size. Smaller values of d₁₀/d₉₀ correspond to a wider, i.e. less narrow size distribution. Mentioned percentages and ratio's are on weight basis. The bulk densities mentioned are loose bulk densities.

In one aspect, the invention discloses a process for the production of enzyme granules characterised in that (a) a liquid enzyme preparation containing one or more enzymes is produced, (b) optionally additives are added to the liquid enzyme preparation obtained in (a), (c) one or more liquid enzyme preparation obtained in (a) or (b) are sprayed into a fluidised bed from below by means of spray nozzles, (d) fine material that escapes from the fluid bed with the off-gas is separated off and returned to the fluidised bed as nuclei for the granule formation, (e) granules of a predetermined size are formed by adjusting the sifting gas stream, (f) the finished granules are discharged via one or more countercurrent gravity sifters installed in the inflow plate of the fluidised bed apparatus and (g) optionally the enzyme granules obtained in step (f) are coated.

Liquid enzyme preparations or slurries can be obtained from a process comprising fermentation of a suitable micro-organism producing said enzyme followed by downstream processing of the fermentation broth. Downstream processing may involve separation of biomass by filtration and ultrafiltration of the cell free fermentation broth. Alternatively, a liquid enzyme preparation or slurry can be prepared by dissolving or partially dissolving a solid enzyme preparation in an aqueous medium respectively. In a preferred embodiment, the liquid enzyme preparation comprises a mixture of at least two enzyme preparations obtained as described above.

Suitable additives which may be added to the liquid enzyme preparation or slurry comprise stabilising agents and/or formulation aids and can be dissolved or suspended in said liquid enzyme preparations at the required final concentrations. Stabilising agents may be added to prevent the enzyme from inactivation during granulation and/or subsequent storage of the enzyme granules. Suitable stabilising agents are well-known in the art and comprise organic and inorganic salts, sugars and other carbohydrates, polyols, substrates and enzyme cofactors, amino acids, proteins and polymers. Formulation aids may be added to improve the granulation process and/or the physical properties of the enzyme granules. Suitable formulation aids comprise filling agents, filming agents, colouring agents, anti-caking agents and salts.

The dry solid content of the liquid enzyme preparation that is sprayed into the granulation bed may vary between 5 and 60 wt %, preferably between 10 and 50 wt % and more preferably between 15 and 45 wt %.

Typically, the air inlet temperature may be between 70 and 220° C. Preferably, the air inlet temperature is between 85 and 200° C., more preferably 100 and 190° C. Typically, the air outlet temperature can be between 35 and 100° C. Preferably the air outlet temperature is between 40 and 95° C. and more preferably between 50 and 90° C.

Fine material escaping from the fluidised bed may be continuously separated off from the off-air with the aid of a cyclone separator or dust filter and returned to the fluidised bed, or an internal return of fines is effected with the aid of a dust filter arranged above the fluidised bed.

At the charge point, one or more zigzag shifters can be used in which the gap length and hence the sifter cross-section is adjustable by means of bars which are connected to one another in comb-like fashion, which are adapted to the zigzag cross section and which are slidable perpendicularly to the axis of the shifter.

The finished granules can be removed via an inflow plate which is divided into several hexagonal segments, which are each inclined towards their centre and have at that point a nozzle and, surrounding the latter, an annular gap-shaped countercurrent gravity shifter as the discharge point.

In a second aspect, the invention provides enzyme granules obtainable by the process of the invention. The invention provides enzyme granules that are characterised by an isotropic structure, a spherical shape and a smooth surface. The spherical shape and smooth surface of the granules is expressed by the roundness factor and lies between 1 and 1.6, preferably between 1 and 1.5 and more preferably between 1.1 and 1.4. The enzyme granules of the invention are further characterised by having an average diameter between 50 and 2000 micron, preferably between 100 and 1000 micron, more preferably between 100 and 750 micron. The enzyme granules of the invention have a narrow size distribution which is expressed as the d₁₀/d₉₀ which lies between 0.3 and 1, preferably between 0.4 and 1, more preferably between 0.5 and 1. The granules of the invention are characterised by a high bulk density, typically between 500 and 1100 gram per litre and a high mechanical strength and a high storage stability.

The enzyme granules of the invention comprise an enzyme fraction and optionally other additives such as stabilising agents and/or formulation aids and optionally an additional coating. The enzyme granules do not contain a carrier or core. The amount of enzyme in the enzyme granules can be as high as 100% resulting in the possibility to have high active granules which will usually depend on the composition of the liquid enzyme preparation that was used to make the granules. Stabilising agents may be added to prevent the enzyme from inactivation during granulation and/or subsequent storage of the enzyme granules. Suitable stabilising agents are well-known in the art and comprise organic and inorganic salts, sugars and other carbohydrates, polyols, substrates and enzyme cofactors, amino acids, proteins and polymers. Formulation aids may be added to improve the granulation process, the physical properties of the enzyme granules and or to arrive at the desired enzyme activity of the enzyme granules. Suitable formulation aids comprise filling agents, filming agents, colouring agents, anti-caking agents.

The enzyme granules according to the invention contain one or more enzymes, preferably enzymes that are used in food and feed. Preferred enzymes are proteases, lipases, redox-enzymes (e.g. glucose oxidase), starch degrading enzymes (amylases, glucoamylases etceteras), non-starch polysaccharide degrading enzymes (cellulases, pectinases, hemicellulases etceteras) and phytases.

A preferred embodiment of the invention is an enzyme granule comprising an alpha-amylase, preferably a fungal alpha-amylase, more preferably an alpha-amylase from Aspergillus species, most preferably from Aspergillus oryzae.

Another preferred embodiment of the invention is an enzyme granule comprising a phytase, preferably a fungal phytase, more preferably a phytase from Aspergillus species, most preferably from Aspergillus niger.

Another preferred embodiment of the invention is an enzyme granule comprising a milk clotting enzyme, preferably a microbial milk clotting enzyme, more preferably a milk clotting enzyme from Rhizomucor species, most preferably from Rhizomucor miehei.

Another preferred embodiment of the invention is an enzyme granule comprising an invertase, preferably a microbial invertase, preferably an invertase from yeast, most preferably from Saccharomyces cerevisiae.

### EXAMPLES

The invention is illustrated by, but in no way limited to, the following examples. The mentioned percentages and ratio's are on weight basis. The bulk densities mentioned are loose bulk densities.

### Example 1

### Enzyme Granules Containing Alpha-amylase from Aspergillus oryzae

In a liquid enzyme preparation containing alpha-amylase from Aspergillus oryzae, magnesium sulphate heptahydrate as a stabilising agent was dissolved to a final concentration of 15% (w/v). This resulted in a solution with a final dry matter content of around 38% and an enzyme activity of 3600 Fungal Amylase Units per gram. The mixture was subsequently granulated in a continuous-fluid bed WSA 225 pilot installation (Glatt GmbH, Weimar, Germany). The water evaporation rate was approx. 4 kg/h and the inlet- and outlet temperatures were 180° C. and 80° C. respectively. The characteristics of the resulting enzyme granules are summarised in Table 1 and compared with granules obtained with multistage drying of the same liquid enzyme preparation including the additives as stated above.

TABLE 1
Properties of amylase containing enzyme granules made with
continuous fluid bed granulation and multistage drying.

| | granulation technique | |
|---|---|---|
| Characteristics | continuous fluid bed | multistage drying |
| Shape | Smooth spherical | Irregular shaped |
| | | agglomerates |
| d₅₀ (micron) | 140 | 140 |
| size distribution (d₁₀/d₉₀) | 0.5 | 0.35 |
| roundness factor | 1.2 | 1.8 |
| bulk density (g/l) | 670 | 350 |
| activity (FAU/g) | 8500 | 8500 |
| activity yield (%) | 85 | 85 |
| residual moisture (%) | 8 | 8 |

One FAU (Fungal alpha-Amylase Unit) is the amount of enzyme that converts 1 gram soluble starch per hour into a product having an equal absorption to a reference colour at 620 nm after reaction with iodine at pH 5.0 and 30° C. and a reaction time between 15-25 minutes. The reference colour is obtained from a solution containing per 100 ml: 25 g CoCl₂*6aq, 3.84 g potassium dichromate, 1 ml concentrated HCl and water.

### Example 2

### Enzyme Granules Containing Phytase from Aspergillus niger

To a liquid enzyme preparation containing phytase from Aspergillus niger at a concentration of 27000 FTU/g and a dry matter content of 27%, polyvinylacohol (PVA Ercol 5/88) as a binder and zinc sulphate hexahydrate as an enzyme stabiliser were added at final concentrations of 1.2% (w/v) each. In two separate experiments, the mixture was subsequently granulated in a continuous fluid bed WSA 225 pilot installation as described in Example 1 whereby the flow was adjusted such as to give the desired granule size (d₅₀—see Table 2). The water evaporation rate was approx. 4 kg/h and the air inlet- and air outlet temperatures were 135° C. and 65° C. respectively.

As a comparison, a liquid enzyme preparation containing phytase from Aspergillus niger at a concentration of 27,000 FTU/g and a dry matter content of 27% was mixed with dry corn starch in a weight ratio of approximately 1:2 in order to obtain an extrudable mixture which was processed in a Fitzpatrick BR-200 basket extruder. The resulting particles were spheronised and dried. The characteristics of the resulting enzyme granules are summarised in Table 2 and compared with granules obtained with extrusion.

One FTU (phytase unit) is the amount of enzyme that liberates 1 micromole phosphate per minute at 37° C. under the assay conditions (0.25 M sodium acetate pH 5.5 and 51 mM sodium phytate).

TABLE 2
Properties of a phytase containing enzyme granules made with
continuous fluid bed granulation and extrusion.

| | granulation technique | | |
|---|---|---|---|
| | continuous fluid bed | | |
| characteristics | experiment 1 | experiment 2 | extrusion |
| shape | smooth spherical | | Near spherical |
| d₅₀ (micron) | 470 | 620 | 600 |
| size distribution | 0.5 | 0.7 | 0.65 |
| d₁₀/d₉₀ | | | |
| roundness factor | not determined | not determined | 1.4 |
| bulk density (g/l) | 588 | 754 | 600 |
| activity (FTU/g) | 83000 | 80000 | 8600 |
| activity yield (%) | 88 | 85 | 95 |
| residual moisture (%) | 8 | 4.5 | 5 |

### Example 3

### Enzyme Granules Containing a Milk Clotting Enzyme from Rhizomucor miehei

A liquid preparation (17.5% dry matter) of a milk clotting enzyme from Rhizomucor miehei was prepared and contained the enzyme at a concentration of 3500 MCU/g and lactose as a granulation aid at a final concentration of 2.5%. This enzyme preparation was subsequently processed in a labscale continuous fluid bed installation (Glatt GmbH, Weimar, Germany). The inlet- and outlet temperatures were 120° C. and 55° C.

The characteristics of the resulting enzyme granules are summarised in Table 3 and compared with granules obtained with fluid bed coating layering using a NaCl crystal as a carrier.

TABLE 3
Properties of milk clotting enzyme granules made with
continuous fluid bed granulation and fluid bed coating
layering using a NaCl carrier.

| | granulation technique | |
|---|---|---|
| | | fluid bed coating layering |
| characteristics | continuous fluid bed | with a NaCl carrier |
| shape | smooth, spherical | round edged cubes |
| d₅₀ (micron) | 200 | 400 |
| size distribution d₁₀/d₉₀ | 0.44 | 0.34 |
| roundness factor | 1.2 | 1.6 |
| bulk density (g/l) | 680 | 650 |
| activity (MCU/g) | 16500 | 7000 |
| activity yield (%) | 95 | 85 |
| residual moisture (%) | 8 | 6 |

One MCU (Milk Clotting Unit) is the amount of enzyme that achieves clotting of 1 ml 10% skim milk at pH 6.45-6.5 at 37° C. and in the presence of 0.1 M CaCl₂ in 40 minutes (equal to one Soxhlet unit).

### Example 4

### Enzyme Granules Containing Invertase from Saccharomyces cerevisiae

A liquid enzyme preparation containing invertase from Saccharomyces cerevisiae was produced. This resulted in a solution with a final dry matter content of around 19% and an enzyme activity of 70,000 invertase units per gram. The mixture was subsequently granulated in a continuous fluid bed WSA 225 pilot installation as described in Example 1. The water evaporation rate was approx. 33 kg/h and the air inlet- and air outlet temperatures were 100° C. and 56° C. respectively. The characteristics of the resulting enzyme granules are summarised in Table 4 and compared with granules obtained with multistage drying of the same liquid enzyme preparation.

TABLE 4
Properties of enzyme granules containing invertase
from Saccharomyces cerevisiae made with continuous
fluid bed granulation and multistage drying.

| | granulation technique | |
|---|---|---|
| characteristics | Continuous fluid bed | multistage drying |
| shape | Smooth, spherical | Irregular shaped |
| | | agglomerates |
| d₅₀ (micron) | 230 | 200 |
| size distribution d₁₀/d₉₀ | 0.4 | 0.35 |
| roundness factor | 1.2 | 1.8 |
| bulk density (g/l) | 550 | 350 |
| activity (Unit/g) | 342,000 | 360,000 |
| activity yield (%) | 91 | 92 |
| residual moisture (%) | 9 | 5 |

One invertase unit is the amount of enzyme that forms 1 mg of invert sugar out of 6 ml 5.4% sucrose under standard conditions (pH 4.5, 20° C., 5 min).

### Example 5

### Enzyme Granules Containing a Milk Clothing Enzyme from Rhizomucor miehi

In a liquid enzyme preparation containing a milk clotting enzyme from Rhizomucor miehi, magnesium sulphate heptahydrate as a stabilising agent was dissolved to a final concentration of 6% (w/v). This resulted in a solution with a final dry matter content of around 11% and an enzyme activity of 2530 MCU per gram. The mixture was subsequently granulated in a continuous fluid bed AGT 150 pilot installation (Glatt GmbH, Weimar, Germany). The water evaporation rate was approx. 2 kg/h and the inlet- and outlet temperatures were 120° C. and 75° C. respectively. The characteristics of the resulting enzyme granules are summarised in Table 5. The superficial air speed was about 3 m/s

TABLE 5
Properties of milk clotting enzyme granules made with
continuous fluid bed granulation and fluid bed coating
layering using a NaCl carrier.

| | granulation technique | |
|---|---|---|
| | continuous fluid bed | fluid bed coating layering |
| Characteristics | MgSO₄ as stabiliser | with a NaCl carrier |
| Shape | smooth, spherical | Round edged cubes |
| d₅₀ (micron) | 140 | 400 |
| size distribution d₁₀/d₉₀ | 0.63 | 0.34 |
| roundness factor | 1.3 | 1.6 |
| bulk density (g/l) | 700 | 650 |
| activity (MCU/g) | 18300 | 7000 |
| activity yield (%) | 82 | 85 |
| residual moisture (%) | 4.5 | 6 |

### Example 6

### Enzyme Granules Containing Chymosin

In a liquid enzyme preparation containing calf chymosin produced by a genetically engineered Kluyveromyces lactis strain, sodium chloride as a filler and processing aid was dissolved in order to reach a final dry matter concentration of 14.5 wt %. The final solution contained 213 MCU per gram. The mixture was subsequently granulated in the continuous fluid bed AGT 150 pilot installation (Glatt GmbH, Weimar, Germany). The water evaporation rate was approx. 2 kg/h and the inlet- and outlet temperatures were 96° C. and 52° C. respectively. The superficial air speed was about 3 m/s. The characteristics of the resulting enzyme granules are summarised in Table 6.

TABLE 6
Properties of chymosin granules made with continuous
fluid bed granulation and fluid bed coating layering
using a NaCl carrier.

| | granulation technique | |
|---|---|---|
| | continuous fluid bed | |
| | with NaCl as filler | fluid bed coating layering |
| Characteristics | and processing aid | with a NaCl carrier |
| Shape | smooth, spherical | Round edged cubes |
| d₅₀ (micron) | 140 | 400 |
| size distribution d₁₀/d₉₀ | 0.70 | 0.34 |
| roundness factor | 1.1 | 1.6 |
| bulk density (g/l) | 1000 | 650 |
| activity (MCU/g) | 1610 | 7000 |
| activity yield (%) | >90 | 85 |
| residual moisture (%) | 1 | 6 |

1. Process for the continuous production of enzyme granules characterised in that:
(a) a liquid enzyme preparation containing one or more enzymes is produced
(b) optionally additives are added to the liquid enzyme preparation obtained in (a)
(c) one or more liquid enzyme preparations obtained in (a) or (b) are sprayed into a fluidised bed by means of spray nozzles
(d) fine material that escapes from the fluid bed with the off-gas is separated off and returned to the fluidised bed as nuclei for the granule formation
(e) granules of a predetermined size are formed by adjusting the sifting gas stream
(f) the finished granules are discharged via one or more countercurrent gravity sifters installed in the inflow plate of the fluidised bed apparatus
(g) optionally the enzyme granules obtained in step (f) are coated

2. A process according to claim 1, wherein the liquid enzyme preparation is obtained from a process comprising fermentation of a suitable micro-organism producing said enzyme followed by downstream processing of the fermentation broth.

3. A process according to anyone of claims 1-2, wherein the additives comprise stabilising agents and/or formulation aids.

4. A process according to claim 1 wherein the stabilising and/or formulation aids are one or more salts.

5. A process according to anyone of the preceding claims wherein the liquid enzyme preparation comprises an enzyme used in food and feed.

6. A process according to anyone of claims 1-5 wherein the liquid enzyme preparation comprises a mixture of at least two enzyme preparations.

7. A process according to anyone of the preceding claims wherein the liquid enzyme preparation comprises an amylase.

8. A process according to anyone of the preceding claims wherein the liquid enzyme preparation comprises a phytase.

9. A process according to anyone of the preceding claims wherein the liquid enzyme preparation comprises a milk clotting enzyme.

10. A process according to anyone of the preceding claims wherein the liquid enzyme preparation comprises an invertase.

11. A process according anyone of the preceding claims, characterised in that the fine material escaping from the fluidised bed is continuously separated off from the off-air with the aid of a cyclone separator or dust filter and returned to the fluidised bed, or an internal return of fines is effected with the aid of a dust filter arranged above the fluidised bed.

12. A process according anyone of the preceding claims characterised in that, as the charge point, one or more zigzag sifters are used in which the gap length and hence the sifter cross-section is adjustable by means of bars which are connected to one another in comb-like fashion, which are adapted to the zigzag cross section and which are slidable perpendicularly to the axis of the shifter.

13. A process according anyone of the preceding claims characterised in that the finished granules are removed via an inflow plate which is divided into several hexagonal segments, which are each inclined towards their centre and have at that point a nozzle and, surrounding the latter, an annular gap-shaped countercurrent gravity shifter as the discharge point.

14. Enzyme granules obtainable by the process as defined in anyone of claims 1-13.

15. Enzyme granules characterised by an isotropic structure, a spherical shape and smooth surface as expressed by a roundness factor between 1 and 1.6 and optionally a coating.

16. Enzyme granules according to claim 15 characterised by a size distribution expressed as d₁₀/d₉₀ which is between 0.3 and 1.

17. Enzyme granules according to anyone of claims 15 and 16 characterised by comprising one or more additives.

18. Enzyme granules according to claim 17 wherein the additive is a stabilising agent.

19. Enzyme granules according to claim 18 wherein the additive is a granulation aid.

20. Enzyme granules according to anyone of claims 15-19 wherein the enzymes are used in food and feed.

21. Enzyme granules according to claim 20 wherein the enzyme fraction comprises an amylase.

22. Enzyme granules according to claim 20 wherein the enzyme fraction comprises a phytase.

23. Enzyme granules according to claim 20 wherein the enzyme fraction comprises a milk clotting enzyme.

24. Enzyme granules according to claim 20 wherein the enzyme fraction comprises an invertase.
